(19) United States
(12) Patent Application Publication
(10) Pub. No.: US 2015/0125831 A1
(43) Pub. Date: May 7, 2015

(54) Tactile Pin Array Device

(71) Applicants: Srijit Chandrashekhar Nair, Farmington, CT (US); Suhasini Ganesan, Farmington, CT (US)

(72) Inventors: Srijit Chandrashekhar Nair, Farmington, CT (US); Suhasini Ganesan, Farmington, CT (US)

(21) Appl. No.: 14/493,480

(22) Filed: Sep. 23, 2014

Related U.S. Application Data
(60) Provisional application No. 61/901,398, filed on Nov. 7, 2013.

(51) Int. Cl. G09B 21/00

(52) U.S. Cl. CPC G09B 21/004
USPC 434/114

(57) ABSTRACT

A handheld electronic device having a tactile pin array thereon is provided for assisting those with vision impairments. The device comprises a set of cameras that can capture a forward image, whereby the image is processed and used to output a three dimensional representation of the image on the tactile pin array. This allows one to recognize objects and obstacles in the area in front of the device, while the pin array may also be deployed as an adaptive braille reader. A specific pin assembly is contemplated using a micro stepper motor, while the overall system provides several functions for visually impaired users, including navigation capabilities, facial recognition, connection to wireless networks, and various input/output means.

### CROSS REFERENCE TO RELATED APPLICATION

This application claims the benefit of U.S. Provisional Application No. 61/901,398 filed on Nov. 7, 2013. The above identified patent application is herein incorporated by reference in its entirety to provide continuity of disclosure.

### BACKGROUND OF THE INVENTION

1. Field of the Invention

The present invention relates to digital assistants and navigation devices for the blind. More specifically, the present invention relates to a method and apparatus that scans a forward area and provides a three-dimensional representation of the area to a blind user, while also supporting several other functions in a handheld electronic device with tactile pin array.

For the visually impaired, navigating from one location to another can be a difficult task. Most common tools used to assist blind travelers include walking canes, seeing-eye dogs, and human assistance. While these are useful, not all provide a complete picture of the surroundings or complete awareness while traveling. As today's world becomes increasingly technology-based, there is a growing need for highly efficient communication and mobility aids for the visually impaired. A traditional walking stick is one example in which the tool may not provide a person with sufficient information about his or her surroundings, and furthermore lacks ancillary functions that can be combined into an electronic assistant as contemplated herein. Alternative aids, such as seeing-eye dogs and personal assistants, are expensive and require a trained, living counterpart for a visually-impaired person to navigate his or her surroundings. These are significant obstacles for most, and a drawback to current methods.

Other existing devices for assisting the visually impaired that assist in everyday interaction with the outside world include refreshable braille displays and speech synthesizers. Refreshable braille displays are powered devices that raise and lower a series of pins in an array to form braille letters, whereby the letters are formed within a row of character cells as the pins raise and lower. This type of device allows a user to read and make inputs to a computer screen using a tactile device. Speech synthesizers, by contrast, are devices that translate an input into a voice message using a text to speech or alternative converter. These devices are useful for translating a message into speech or for interpreting an input and producing a vocal message for others to hear. While not related to navigation, these devices are significant tools for visually impaired individuals to interact with the outside world and to operate electronic devices such as computers.

The present invention contemplates a handheld device that draws from both tactile device and speech synthesizer technologies to provide a multi-function handheld device that can communicate with the user using a tactile array and via a speaker output. Handheld devices in the art are common place in today's society. These devices have revolutionized the way in which we interact with one another and obtain information. Most handheld electronic devices, such as smartphones and tablets, have several functions, including wireless connectivity, feedback in the form of audible, tactile and visual signals, image capture means, and many others. The present invention contemplates a handheld electronic device that is particularly suited for the visually impaired, wherein a tactile array of pins is provided, along with several input and output features to allow a user to navigate and interact with the world around him using a continually updating digital device.

Specifically, the present invention comprises a digital mobility aid for the visually impaired that comprises a handheld electronic device having a tactile feedback system, a depth sensing camera for capturing an area forward of the user, and various accessories that function to assist the user in navigating and interacting with his or her environment. The camera captures an area in front of the user, wherein the image is processed and relayed to a tactile pin array to recreate the three dimensional image for the user to “feel” the path in front of him, and likewise any obstacles. Furthermore, several electronic accessories are included to assist the connectivity and awareness of the user, including: a GPS module, a wireless antenna, a microphone and speaker, an accelerometer, haptic feedback, and a processor with various applications specifically for the visually impaired. Overall, the present invention is a system, method, and new apparatus that provides a new handheld device for visually impaired users, whereby increased awareness, connectivity, and mobility are afforded.

2. Description of the Prior Art

Devices have been disclosed in the prior art that relate to braille reader systems and tactile feedback devices. These include devices that have been patented and published in patent application publications. These devices fail to provide a comprehensive, multi-function handheld device that assists visually impaired users navigate and connect with the outside world in the manner described below. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 8,388,346 to Rantala discloses a method and apparatus for converting textual and graphical information from a display screen (e.g. a computer monitor or the like) into a tactile feedback device for blind individuals to recognize the depicted objects and interact therewith. The textual and graphical information is converted into instructions, which pulses an actuator in the form of Braille characters.

Similar to Rantala is U.S. Patent Publication No. 2008/0252607 to De Jong, which discloses an image display that includes a pixel-actuator matrix having a set of actuators, whereby the actuators move a series of rods that move in response to an electrical input. The assembly is adapted to provide feedback for a user when the user engages the image display, wherein the image display provides a touch-sensitive assembly whereby the user feels an object, texture or surface.

U.S. Patent Publication No. 2008/0174566 to Zuniga Zabala discloses a system that allows a blind user to perceive shapes displayed on a screen from a tactile device. An imaging processing software and hardware are used to translate an image into a tactile display for the user to feel what the image is providing to sighted users.

While these devices relate to feedback devices for the visually impaired, they fail to anticipate a system that can capture images of a forward area and translate those into a tactile array using raised pins. Furthermore, the prior art devices fail to disclose a handheld electronic device that supports several functions that improve connectivity, awareness and navigation for one with a visual impairment. The present invention comprises a handheld device that can provide information to the user regarding the area in his surroundings, allow the user to navigate to a desired destination without visualizing the path, and one that can facilitate communication and connectivity using various feedback and input means on the handheld device.

Overall, the present invention substantially diverges in design elements from the prior art, and consequently it is clear that there is a need in the art for an improvement to existing handheld electronic devices for the visually impaired. In this regard the instant invention substantially fulfills these needs.

### SUMMARY OF THE INVENTION

In view of the foregoing disadvantages inherent in the known types of handheld electronic devices for the visually impaired now present in the prior art, the present invention provides a new system and method that can be utilized for providing convenience for visually impaired users when navigating between destinations, interacting with the environment, and connecting to information sources.

It is therefore an object of the present invention to provide a new and improved handheld electronic device for the visually impaired that has all of the advantages of the prior art and none of the disadvantages.

It is another object of the present invention to provide a handheld electronic device that provides a pin array assembly that can form a real-time, tactile representation of images and furthermore operate as a braille reader for a visually impaired users.

Another object of the present invention is to provide a handheld electronic device that can scan an area ahead of the device using a camera, whereby the image is processed and translated into a tactile representation of the environment forward of the user.

Yet another object of the present invention is to provide a handheld electronic device that assists visually impaired individuals navigate through a given environment by providing a tactile representation of obstacles ahead, while at the same time operating as a multi-function device with navigation capabilities and the ability to communicate with the user or receive commands therefrom.

Another object of the present invention is to provide a handheld electronic device that has general smartphone or tablet capabilities, while also providing a tactile pin array that has multi-function capabilities.

Another object of the present invention is to provide a handheld electronic device that includes image processing capabilities such that three dimensional images can be captured, interrogated, and then translated into a pin array representation using the tactile pin array.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system diagram of the present invention.

FIG. 2 illustrates a view of the handheld electronic device and its tactile representation of an image that is captured in front of the device.

FIG. 3A shows a close-up view of a single pin from the tactile pin array, in which the pin is in a lowered position.

FIG. 3B shows a close-up view of a single pin from the tactile pin array, in which the pin is in a raised position.

FIG. 4 shows a flow diagram representing the steps of the tactile representation algorithm when navigating through an environment with a set of obstacles.

FIG. 5 shows a flow diagram of the algorithm used to analyze a captured image for faces, and then cross-referencing the processed image for known faces stored within the device for facial recognition purposes.

### DETAILED DESCRIPTION OF THE INVENTION

Reference is made herein to the attached drawings. Like reference numerals are used throughout the drawings to depict like or similar elements of the handheld electronic device of the present invention. For the purposes of presenting a brief and clear description of the present invention, the preferred embodiment will be discussed as used for assisting visually impaired users when navigating through an environment, interacting with others, and connecting to information sources. The figures are intended for representative purposes only and should not be considered to be limiting in any respect.

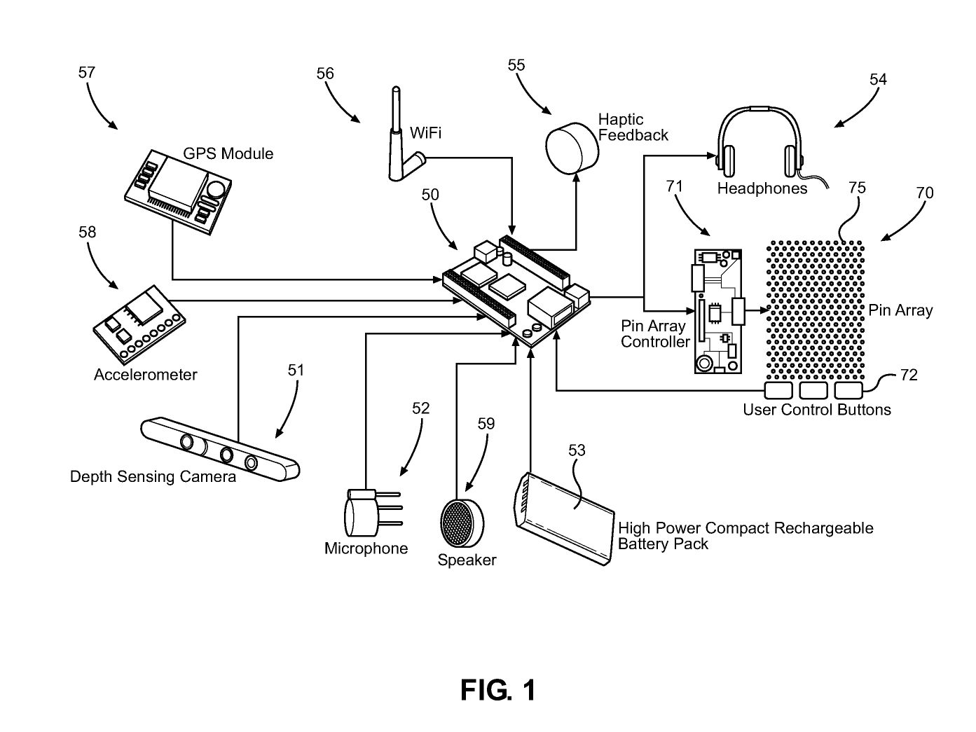

Referring now to FIG. 1, there is shown a system diagram of the present invention in which the functional elements are provided. The system is one that can provide several features for a visually impaired user in the form of a handheld electronic device. The device supports several different functions, including forward obstacle mapping in the form of a tactile representation, a means of inputting or receiving braille text through a tactile pin array, process and register faces of those in front of the device, as well as other connectivity and interactive features that are commonly found on smartphones, tablets and the like. The present invention contemplates both a system and a method for assisting visually impaired users, whereby their ability to navigate and recognize the environment around them is enhanced, while at the same time the user is provided connectivity to outside networks and interaction that is commonly found in a handheld electronic device (e.g. navigation, access to networks, audio input and output, et al.)

The handheld device comprises an external pin array 70 comprised of individual pins 75 that can raise and lower from the surface of the handheld device for providing tactile input to the user. The pins 75 can each move upward a defined height to form a defined surface profile that may be used to define a tactile representation of a three dimensional image, and further for providing braille feedback to the user. A pin array controller 71 is provided that controls the position of each of the pins 75 in the array, wherein signals are processed from a microprocessor 50 to define a specific picture, message, or three dimensional shape on the array 70. The processor 50, memory, storage, and a power source are used to operate the handheld device.

Along with the tactile pin array 70, the microprocessor 50 controls and interacts with several additional components of the system to provide a multifunctional device. Most notably, the system further comprises a three dimensional, depth sensing camera 51, which can take high resolution camera images in front of the device and the processor can process the captured image. The depth sensing camera comprises at least two camera apertures that function to determine the depth of items captured on an image, whereby the processor 50 of the system can interrogate the image and determine relative positioning, depth, and dimensions of the area in front of the handheld device. After processing, the image is translated into commands to the pin array controller, which then can replicate the three dimensional image on the tactile pin array 70. This allows a user to “feel” the environment in front of him, thereby avoiding objects without the use of a cane, seeing eye dog or a companion.

Further provided on the device is a wireless network antenna 56 for connecting the device to a local network (e.g. WiFi or the like), as well as a GPS module. The wireless network antenna 56 is used to connect to the internet through a local network, wherein data is received from the network and processed by non-transitory computer-readable media on the processor 50 for running various applications that may be available on the interface layer of the device. It is desired to provide a handheld electronic device with several functions, whereby the device may duplicate as a tablet for the user and provide output via the pin array 70. Connection to an external network further facilitates software updates when available to the device.

The Global Positioning System (GPS) module is used for navigational purposes. The device can be used to navigate outdoors and from one location to another. The GPS module, in coordination with the process 50, are used to track the location of the handheld device, provide positional information to the user, and further provide navigation instructions that can be delivered via the tactile array 70, via speakers 59, or via a speaker headset 54. In this way, the device can form a GPS unit for guiding a visually impaired user when traveling outdoors.

Further provided on the device is an accelerometer 58, a microphone 52, one or more speakers 59, and user control buttons 72 having haptic feedback. The accelerometer 58 is useful for determining change in position of the handheld device, wherein several applications may desire this information for various functions. The microphone 52 is used to accept audible inputs from the user and the surroundings, wherein a voice-activated application may be employed to control the device if so programmed. The speakers 59 are used to provide audio inputs to the visually impaired user, whereby navigation waypoints and other information can be relayed via the speakers or via a pair of headphones 54 connected to an audio jack. Finally, the user control buttons 72 are physical inputs for the device, wherein haptic feedback 55 may or may not also be provided for improved interaction. Powering the assembly is a rechargeable battery power source 53, which is rechargeable and optionally replaceable.

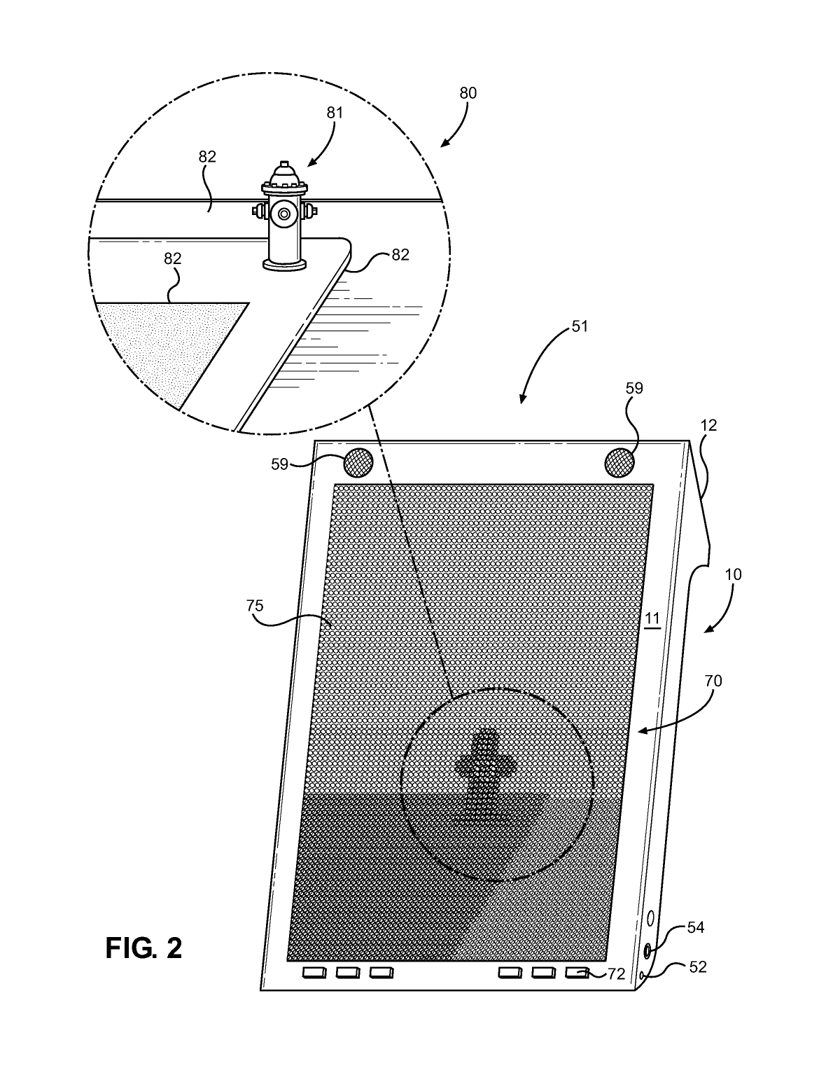

Referring now to FIG. 2, there is shown an illustration of the system capturing an image 80 in from of the device, processing the image, and then presenting a three dimensional representation of the image on the tactile pin array 70. At least two cameras 51 are disposed along the leading edge of the device, each of which capture an image forward of the device from different perspectives. The images of both cameras are processed to form a stereoscopic image that has three dimensions, whereby the relative depth and location of items is translated into the arrangement of the pin array 70 for the user to interrogate with his or her hand. A non-transitory computer-readable media, which comprises all computer-readable media except for a transitory, propagating signal, is used to generate positional data on the images, combine the images into one stereoscopic image, and then translate that image into data for the pin array controller to control each individual pin 75 in the array 70.

The cameras can be set to take continuous images, wherein images from left and right cameras are processed to create the three dimensional data used to represent the forward environment on the array 70. Objects 81 in the path of the user and various surface changes 82 are captured such that the visually impaired user can recognize hazards before him and make necessary adjustments. This is useful both indoors and outdoors, whereby a continuous feed of images provides for a continuously updating pin array 70 that changes with the changing environment in front of the device 10. The pins 75 raise and lower on the upper surface 11 of the device 10 such that the user to physically interrogate the surface, thereby alerting the user to incoming objects, walls and other hazards. It is contemplated that the device 10 be hand-carried or supported along its lower surface from a wheel chair or similar mobility chair. The forward portion 12 of the device is directed forward of the user for accurate representations of the area in front of the user.

Along with the tactile representation of the forward area, it is contemplated that the array can be used to recognize faces of those in front of the user, whereby the camera images are processed and data points of recognized faces are compared to data points of stored photos. The processor can then output a name from the speakers 59 or from the audio jack 54 that corresponds with the photo of the person. User input buttons 72 and the microphone 52 are used to make inputs to the device, whereby different applications stored on the device can be initiated as desired. The pin surface can serve as a braille surface or braille reader device.

An ARM based processor board will run OpenNI and other image processing algorithms to interpret data from the cameras, accelerometer and GPS unit to understand the location, terrain in-front of the device and the orientation of the device. Onboard facial recognition algorithms can learn faces of family and friends and identify and alert user if anybody is nearby. The on board microphones can listen to surroundings, while the microphone enables listening to voice commands given by the user. The image processing algorithms will process depth data and convert the terrain information to surface map. The surface map representation of the terrain will be fed into the pin array controller that controls the height of each of the pin on preferably 100×80 pin array. GPS data can also be used to navigate user or provide necessary information about the area to the user. Text to speech software will generate speech which can be heard using the headphones/speakers, while haptic feedback can also be given to user for various types of situations that need immediate attention. The user can download regular or braille books and can read using the pin array

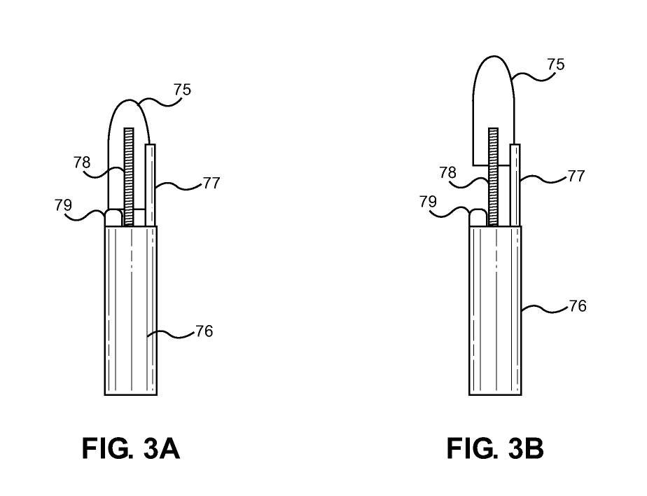

Referring now to FIGS. 3A and 3B, there is shown a view of the individual pin assemblies of the present invention. Each of the pins is a tactile pin head 75 that is raised and lowered using a micro stepper motor 76 that rotates a threaded rod 78 extending through the pin head 75. The stepper motor 76 rotates the rod 78 a defined rotation to lift the pin head 75 a calibrated height, whereby full extension (FIG. 3B), full retraction (FIG. 3A), and minor height changes of the pin head 75 between full retraction and full extension are possible. This allows the entire pin array to form a smooth surface, as opposed to using an array of binary pins (only fully extended or fully retracted).

The threaded rod 78 rotates and remains vertically stationary. The threads of the rod 78 engage a complimentary thread pitch along the interior of the pin head 75. The pin head 75 is prevented from rotating in coordination with the rod 78 by way of a stationary pin guide 77. The pin guide 77 is positioned within a slot in the pin head 75, whereby pin head is resisted by the pin guide 75 such that the threads of the rod 78 force the pin head upward or downward depending on rotation and the pin head stays rotationally static. This causes the pin head 75 to raise or lower using the rotational input of the threaded rod 78 and the stepper moto 76 input. The stepper motor is preferably a 5 mm diameter micro stepper motor which has a threaded rod. A lightweight aluminum pin head fits onto the micro stepper motor rod, wherein the pin head moves up and down as motor rotates. A retraction switch will sense fully retracted position of the dowel pin to deactivate the steeper motor when retracting the pin head 78.

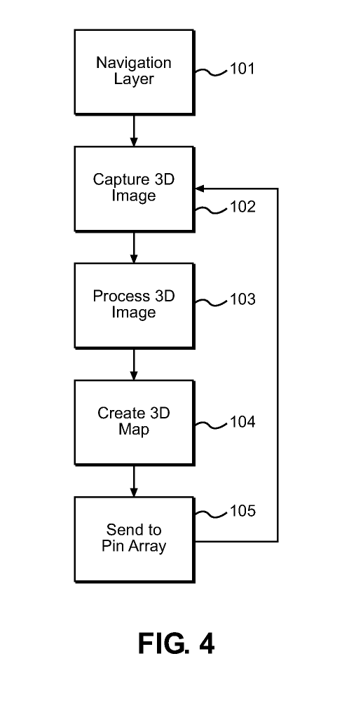

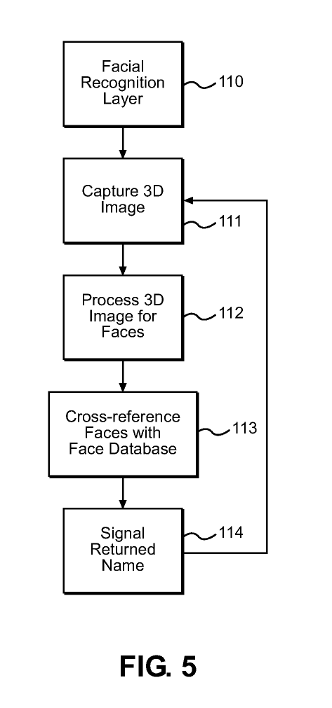

Referring now to FIGS. 4 and 5, there are show two algorithms deployed by the device for creating a three dimensional terrain map for an area in front of the device, and for recognizing faces from the captured images. For the navigation, once activated 101, captures an image 102 from each of the two cameras from the device, whereby the captured image is processed 103 into three dimensional data that can be used to create a three dimensional map 104. The map is translated into commands for the pin array controller and sent thereto 105. Thereafter, subsequent images can be taken and processed to provide a continuously updating array for the user. Similarly for the facial recognition algorithm, once initiated 110, the cameras capture an image 111 that is processed 112 and cross-referenced with a database of known facial photos. The name associated with the recognized face is returned 114 from the database and output either as a braille signal or via the speakers for an audio alert.

The present invention is a digital mobility aid for the visually impaired. The invention comprises an electronic handheld device with a 3D camera system and a surface of movable pins used to create a raised display surface. The 3D camera system scans and interprets the area immediately in front of a user. Then, the pin surface can present the three dimensional image on the pin array. Alternatively the pin array can function as a Braille-based input and output surface. The camera images are process and commands are sent to the pin array, whereby the pins create a formation representative of the landscape in front of the person.

In use, the device is an aid to the visually impaired. The device can replace canes and seeing eye dogs as a means to guide an individual. As a person places his hand on the pin system, he or she can learn from the tactile responses about the surrounding area. Unlike a cane that is limited to the immediate surroundings, the pin system would reflect a map and indicate more items such as walk ways, curbs, building, parking meters, and the like. In addition to the use of a three dimensional grid to identify obstructions, the device includes voice feedback to indicate immediate or imminent obstructions for the individual. The voice feedback is important in relaying information that may not be able to be presented effectively or quickly to the individual. Instances where this may occur is when walking into a building or when walking around low hanging trees. In these situations, it is not possible for the braille reader to indicate to the user that an obstruction is directly above his head. The audible system would be able to alert the user and let the user take the proper precautions while walking to avoid injury.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electronic device having tactile feedback, comprising:
a processor, memory, storage, and a power source;
one or more cameras for capturing one or more simultaneous images;
a pin array comprising at least one pin assembly;
each pin assembly comprising a pin head that is height adjustable using an electric motor, said pin head having a fully extended state and a fully retracted state;
a pin array controller for controlling each of said electric motors.

2) The electronic device of claim 1, wherein:
said pin assembly further comprises a micro stepper motor rotatably controlling a threaded rod;
said threaded rod secured within a threaded aperture in said pin head;
a pin guide engaging a groove in said pin head to prevent rotation thereof;
a retraction switch to sense said fully retracted state.

3) The electronic device of claim 1, further comprising at least one speaker.

4) The electronic device of claim 1, further comprising a GPS module.

5) The electronic device of claim 1, further comprising a wireless network antenna.

6) The electronic device of claim 1, further comprising a microphone.

7) The electronic device of claim 1, further comprising an accelerometer.

8) A tactile pin assembly, comprising:
a micro stepper motor rotatably controlling a threaded rod;
said threaded rod secured within a threaded aperture in said pin head;
a pin guide engaging a groove in said pin head to prevent rotation thereof;
a retraction switch to sense said fully retracted state.

9) A method of providing tactile feedback, comprising the steps of:
capturing one or more images of an area using one or more cameras;
processing said one or more images for depth and spatial relation of objects in said area;
transforming said depth and spatial relation into machine-readable data;
using a pin array controller to transform said machine-readable data into individual commands for an array of pin assemblies along a pin array;
moving each of said pin assemblies to correspond with said individual commands as to create a tactile representation of said objects in said area using said pin array.

10) The method of claim 9, further comprising the steps of:
using said depth and spatial relation of objects in said area to search for facial patterns;
comparing said facial patterns to a database of stored facial patterns to find a match;
returning a name corresponding to said match if found.
